(19) United States
(12) Patent Application Publication
(10) Pub. No.: US 2025/0342248 A1
(43) Pub. Date: Nov. 6, 2025

(54) Cybersecurity Encryption of Computer Software and Data: Random Code Translation, Transaction, and Transmission on Devices Connectable to Networks

(71) Applicant: Sebastian Tiberius Glory, Ash Fork, AZ (US)

(72) Inventor: Sebastian Tiberius Glory, Ash Fork, AZ (US)

(21) Appl. No.: 18/655,779

(22) Filed: May 6, 2024

(51) Int. Cl. G06F 21/56; H04L 9/08

(52) U.S. Cl. CPC G06F 21/56; H04L 9/0861; G06F 2221/034

(57) ABSTRACT

The present disclosure relates to cybersecurity methodology through a process of encryption platform programs which blocks breaches from multiple sources on connectable computer devices across networks. This non-transitory system translates code of any computer language into a layered encryption readable only by the translation matrix which created the encryption. Each piece of software and data group on any given device is individually encrypted and isolated from one another on the device and further isolated from outside networks and devices connected to those networks. Foreign code of viruses and malware not translated into the authorized encryption of a software program or data group are recognized, isolated, and removed before secure connections are made for translation, transaction, and transmission of any software or data. The encryption platform secures incoming and outgoing software and data before connecting to touch-points, reading translations, and interacting with software uploads or updates and data integration.

### FIELD OF THE INVENTION

This invention relates generally to cybersecurity encryption in computer networks and computer devices connected to these computer networks, and, more specifically, to blocking breaches by multiple sources, either biological (e.g. humans) or artificial (e.g. artificial intelligence) using random code translation readable only by the translation matrix of the encryption platform.

### BACKGROUND OF THE INVENTION

Businesses, non-profits, and government agencies are faced with the ever-increasing risks from computer security threats. Some cyberattacks are perpetrated by outsiders. Other threats originate from bad actors within. Organizations typically run various cybersecurity products from different vendors. For example, one vendor may detect for viruses and malware installed on user devices, and another vendor may model and analyze user behavior to detect anomalies. Each of the products generate alerts when a suspicious activity for which they are monitoring occurs or attempts to fight off the suspicious activity. For large organizations this may even mean full time staff actively writing code to fight back in real time. A large volume of daily attacks can lead to a big expense.

Smaller organizations are not equipped with the necessary resources to combat these breaches. Even mid-side and large organizations that can afford the growing cost of software and professionals to block only a portion of the attacks on the integrity of private information, sensitive data, top secret documents, and necessary devices that maintain our everyday lives. Many very public displays of the cybersecurity industry's failures to protect our computers have left the world wondering why we spend almost a trillion USD annually for cybersecurity while losses still amount to over $10 trillion.

Many of the everyday hacks are not accessing company secrets, but personal and often sensitive information of their customers. This includes social security numbers and contact information of relatives and friends. Scams using this data have grown rampant and the average person falls prey to scammers with access to either convince an individual to pony up the dough or to directly use tactics of identity theft. For example, a scammer with specific identifying information can process a home loan in another person's name with no intention of ever paying back a dime.

Hackers gain access through email, apps, and other ways on personal devices and company computers. Any point of weakness is a means of entry. An innocent website about a book you are reading or a recipe for cooking that night's dinner can be infected with malicious code ready to spread at the click of an otherwise innocuous button.

Every day, decisive attacks go after defined targets. Yet, hundreds of new malware programs are written and dispersed daily. Tens of thousands of programs are randomly fishing through networks across the globe.

Artificial intelligence is here. Hackers will use it to better break the defenses of cybersecurity professionals. In fact, as AI develops the intelligences themselves may very well come after human devices in order to take down their predecessors.

It is impossible to defeat every enemy at every point of incursion. How best to stop computer breaches than by making it impossible to read any code on any device without the explicit authority to do so?

### SUMMARY OF THE INVENTION

The encryption platform disclosed within is a package of software programs working together in a visual interface, the method of each software a piece of the process of encrypting, reading the encryptions, and securely sending and receiving encryptions. The process enhances security of all software and data on a device and devices across networks while never hindering the transmission of downloads or uploads of software or data. Coding of any software or data is translated into an encryption using the translation matrix. Each software program and data group is translated differently at random by the translation matrix.

At the center of the encryption platform, which is also encrypted, is the core. The core directs the activities of all software that makes up the encryption platform and connects all software and data to all other software and data on a device, including all incoming and outgoing flows of software and data across networks. Every download of a new piece of software creates a secure connection by way of a unique touch-point in the code that cannot be replicated by an outside source.

Each individual translated software program or data group includes a translation legend. This legend is used by the translation matrix to read the code so the core can transmit the code and the OS and other software and data can interact within secure intended limits of the software and data. Software and data are never decoded; the translation matrix works as a translator between encryptions through the core.

A ledger of encryptions is recorded by name and date. The encryption translations are read by the translation matrix but not available to the naked eye without going through an in-person diagnostic process set up with an identification system at the time of original device initiation. Only the authorized owner can access this backup system in case the primary backup process is unavailable through a pre-authorized secondary device. Multiple devices can be backed up and shared on a private, group, team, or organization-wide network of devices based on optional settings.

### DETAILED DESCRIPTION OF THE INVENTION

The encryption platform is a group of software programs forming a process system with a webbing of methods working in unison to secure data over networks and on connectable devices: (2) translation matrix, (3) ledger of encryptions & code sharing, (4) encryption formatting, (5) self-breach barrier, (6) touch-points, (7) scanning for ‘hitch-hiking’ codes, (8) data sharing, (9) the core, (10) app store gateways, (11) non-store app security, (12) unsecure app partition, (13) data transfer systems, (14) diagnostic systems, and (15) a visual interface platform.

The translation matrix is the program for creating random encryptions and, in hand with encryption records or an encryption legend held within an individual encryption, interprets existing translations. The translation matrix encrypts and reads software programs (including the OS) and data groups either held within a device or sent over computer networks to another computer device. The matrix does not decrypt except under certain circumstances such as by the original software developer or for the purpose of re-encryption on another device or transfer of information; that is, the matrix under most circumstances only translates requests by the OS or other software programs. The matrix also reads code touch-points in software through the core for interacting with software not encrypted by the device the software is run on. A legend encoded into each encryption is the dictionary used by the matrix for translation. Multiple types of intertwined encryptions are utilized for each translation process. Types of encryption can include, but are not limited to: traditional encryptions, any spoken language; mathematic equations; shapes, wave lengths, graphs; mapping coordinates; generative AI; shuffling of encryptions. The operating system of each device is encoded uniquely with encrypted translation previous to leaving the factory in which the OS is installed. OS updates arrive normally, except these updates process through the core of the encryption platform. Existing computer devices can be upgraded with the encryption platform. Individual software programs would be fully protected from one another. However, to ensure each software program and data group is not pre-compromised the best policy would be to reformat the device to factory settings. Furthermore, for the best results of software and data interaction new lines of code will be required in applications, inserted by developers, in order to interact fully with the data sharing program. Each software program is translated differently than any other software program. Each application is encoded by its developer using the encryption platform. Applications are translated differently so no application can access another except via approved transfers through the core. The encryption platform also creates temporary translations with a data expiration timer and secondary confirmation. When sending only informational data to another source, a human interacting on the other end can input a confirmation code on another device (e.g. smart phone) or through a secure transfer in an encryption platform account.

Records of resulting encryptions from the translation matrix are kept in a ledger program. All codes used on a device, and codes of all shared devices (for access and backup purposes) are stored securely in translation records of the encryption platform. If and when a device becomes inoperable, the backup on another secure device will ensure visual user access to networked devices which do not have a screen interface, such as appliances. Translation codes can also be secured on cloud storage in an encryption platform account or backup accessed by means of identification verification if no other device has access to the specific encryption platform profile. Also, devices could be accessed directly with a certified diagnostic tool equipped to interface with the encryption package. However, if the encryption translations are degraded then an external diagnostic tool would not be of useful assistance. Encryption records are organized by dates & time, use of software, and designations. Designation types separate encryption records because there are different touch-points in encrypted software and data (e.g. the OS to the core or the core to a software program or the core to an app store). A translation code sharing program allows records to be shared across networks with varying devices as personal, group (e.g. family), team, or company. This sharing of records allows secure access and management of all your networked computer devices: computers, smart phones, ear buds, appliances, toys, nanny cams, vehicles, and work systems (e.g. trains & airplanes & ships, utilities & nuclear plants, satellites, military drones). Sharing of records also allows group use of encrypted data kept in on-site servers or cloud storage. Sharing one code record does not include sharing all code records of a device.

The encryption platform contains the format for blocks of code to create a translated structure and the capability to read the encryptions in order to interact with them. By clicking the ‘translate now’ button, with either the information below or a popup box appearing to enter translation options, the code for a software program or piece of data will immediately and randomly encrypt itself and the encryption translation will be recorded in the ledger. Examples of options would be: a) To encrypt software for commercial use by a group of users, big or small, or b) encrypt data to store in a cloud server for later use, or c) sending a timed encryption with secondary confirmation to receiving user. Only the computer device which translates a software program or data group has the ability to decrypt it, with the exception of timed encryptions that decrypt themselves after secondary confirmation of the receiver. Within the translated code is: i) The original code for the software program or data group, ii) a translation legend which allows the software to work with a device's encryption platform, operating system, and other software on the device, iii) an internal barrier system within software to protect the program from itself (4), iv) touch-points: access points for software interaction through the core (5), and v) data sharing code which permits sending requested data and, also, requests certain data from the OS, other apps, and outside networks through the core using the data sharing center (7).

Interior barriers of code are designed to protect one part of a software program from another part of the same program. Self-breach occurs with certain types of applications. For example an internet browser contains trillions of connections, all of which are potentially dangerous to a computer device, but also can be points through which a hacker could access sensitive information stored within the browser itself. While the primary software encryption contains the internet browser in its whole from affecting the remainder of a device, interior barrier encryptions create additional protection for each tab from each tab and parts within all tabs (e.g. extensions for crypto wallets). A browser extension of the encryption platform speeds up the interaction between these internal barriers so as not to slow down the user experience of a web browser.

Touch-points are multiple secure access points or block of code written into encrypted software and data that work through the core. Touch-points are a one-to-one “lock & key” system. Touch-points are placed accordingly by a software developer for specific uses based on the type of software or data being encrypted. In general, these touch-points are in the core of the encryption platform and interact with touch-points of the OS and all other software. The OS and all software programs on a device create a unique encryption at the touch-points when initialization occurs. That is when each download happens a new touch-point encryption is formed with the core and the software so no outside program can hack the touch-point. This is because the initial touch-point, even though encrypted differently for each software program, is the same for every copy of the software downloaded on each device. These touch-points are recorded in the encryption platform for continued use with app store updates and interactions with web based activities of the app. Touch-points are also placed into encoded data for transport and cloud storage. Integration or reintegration of encoded data stored elsewhere happens through the core using touch-points.

The encryption platform includes a data scanning program. The scanning of incoming and outgoing software is specifically looking for ‘hitch-hiking’ code. That is code which is not properly translated using the translation matrix. The encryption platform's purpose is to translate and read the translations of software programs and data groups. It is not meant to combat an attack by malicious code but, in fact, block said malicious code from ever entering a computer device's systems in the first place.

The data sharing center makes possible for requests to be received and permissions to be sent between software programs, as well as interacting with incoming and out-going data across internet, intranet and extranet systems. Software and data groups originating within apps transfer within the app freely. Most cases of free flowing data will be limited to updates of an app by its developer. For external data types (e.g. page links, pictures, videos, a block of text) the data can connect in limited ways through touch-points. Data can be shared without any recognizable delay by a user and without laying bare the code that could be hacked or infected with a virus. Data sharing also permits copying certain approved data to send for use in another application. What data is sharable is based on what the software application's limits and capabilities are before encryption. A data report shows all data being requested and sent. This report is a user interface with a point-by-point checkbox option for types of data to allow or not allow until explicit permission is given. The report also comes up automatically for non-regular data. Both internal and external transfers of data show up on the report. The report watches for any strange code attempting to covertly make requests for data without a visual cue in the report queue. All data, no matter what type, is recorded through the report. The full report stays on the computer. Suspicious code is automatically reported for review while the specific data is not shared for privacy reasons.

The core oversees and directs all activity between software on a device and transmissions across networks. It is the brain and central Hub through which all downloads and updates, uploads, and data passes through. All other software in the encryption platform runs through the core because the core contains all the touch-point connections for all software on a device. When new software is downloaded on a device a new encrypted touch-point is created specifically connecting the software to the core. This touch-point is for all app activities, including updates and app functions. Another touch-point is made to the app's internet connections through the app store.

All applications are uniquely encoded for downloads, uploads, and updates; the only access to these apps from outside each app is by pre-granted approval through a touch-point. Apps are further encrypted by a registered App Store in order to pass through the App Store for approved download on a secured device using the encryption platform. These App Stores are authorized by device manufacturers and the encryption platform to access these devices for software upgrades and program activities.

Non-store software downloads are possible either by direct download or by the organization app system within the encryption platform which allows for the use of proprietary or top secret software utilized by employees of businesses, non-profits, or government entities.

The unsecure app system within the encryption platform encrypts software and data on a given computer device for software not yet processed for encryption through either an encrypted public app store or encrypted organization app system, but interacts across networks and through unencrypted app stores. The primary reason for the unsecure app system is to secure apps on any single device previous to an industry wide acceptance and usage of the encryption platform.

Data transfer systems (e.g. satellites and modems) are very susceptible to hacking. These devices can be updated with the encryption platform. Each type of computer device receives either the full encryption platform software package or a sub-package meant for devices which do not have complete user interface capabilities (e.g. appliances, remote utility devices, an internet modem, or a satellite in space) or are too small for the entirety of the encryption platform software package (e.g. a wireless earpiece or nanny cam).

Access capabilities are necessary for diagnostic tools, online and in direct proximity. The diagnostic system is designed to appropriately provide remote access for existing diagnostic procedures and tools, as well as direct diagnostic devices. Diagnostic devices are built to plug directly into any given device or connect wirelessly in proximity to the device. This is needed so any diagnostic device is able to sync with the core and translation software for device diagnosis.

The encryption platform is a visual user interface for the purpose of interacting with all of a computer device's data encryption activities. The visual interface platform works across networks over multiple devices in private, family, team, and organization settings. Not all devices have a visual display interface. The platform allows for secure connections to other devices over secure networks. A user of the platform sets up an account to further back up all encryptions for each device. A user receives notifications through this account about security updates as well as any access by other members of a network: family, team, or organization. A team or organization assigning a device has priority to reset ownership of a company device and block or remove a device from a shared network.

### EXAMPLES

### Example #1: Translation Complexity

The point of the translation matrix is to make too many encryptions which can be read only by the device that created them. Imagine, first a code is translated into a foreign spoken language then shuffled by a random number of spots. The scrambled language is now transformed into numbers. These numbers create functions and equations are written to represent these functions. Points in AI art may be used as inputs for a mathematic equation which in turn must line up to a function. A library of one million subjects altered by AI each one million times, for example: a single object chosen is a dragon; type, colors and actions of the dragon; background. A random number of points on a random number of randomly selected AI art pieces of different subject matters can then be inserted correctly into the above math equations to form the particular functions. Any hacker or AI may understand the translation matrix. However, the convoluted encryptions of each software program and encrypted data stream make any decryption process impossible without the keys required to unlock the codes.

### Example #2: Hitch-hiker Code

Hitch-hiking code is any code not translated into the associated encryption. Any code not properly encoded to the translation in use is likely unauthorized, malicious code. The scanning process will locate, isolate and delete hitch-hiking codes.

### Example #3: Self-breach of Applications

Email on an internet browser is the primary, though not only, example of self-breaching activity. An internet browser is a single software application translated into encryption and isolated from other software programs. Each browser tab, however, can interact with another. Many malware and hacking activities occur through email phishing. By creating additional barriers between browser tabs and of various add-on software within a browser (e.g. extensions), hacking activity is limited to the email account itself. Further, each email received can be isolated from the remaining email account.

### Example #4: The Trojan Horse

Unfortunately, app stores do not have enough managing over-site for the apps they allow to be downloaded on devices. The encryption isolates apps from one another and data sharing allows requests of data while limiting a free-for-all hack or virus infection of a device by any one application.

### Example #5: Cloud Storage

Off-site data storage has become very popular. Cloud storage has also become the number one attack scenario for hackers. Large amounts of sensitive data stored in one place makes for an enticing target. It used to be private pictures and the next big novel that needed protecting. Now it is social security numbers and other identification information used for identity theft and scams, band account access codes, and pentagon military secrets. Secure cloud storage is possible when none of the information can be translated by every looky-loo.

### Example #6: Other Devices

Devices without a visual interface can be fully secured by encryption and the encryption platform of a laptop or smart phone can be used to interact with the device securely. Upon newly purchasing a device, a buyer sets up the device within their encryption platform account. This setup process creates unique touch-points with the encryption platform account and the device or devices with which a user intends to use the accessory device.

1. A process performed by a computer for allowing authorized access while denying access of digital systems to a breach by malware, viruses, and hacking from multiple sources, the method comprising: (a) an encryption made by a translation matrix utilizing multiple random translation types per one encryption, making it an infinite number of possibilities what the original code was before the encryption occurred; (b) a system of recording, naming, and tracking all encryptions in a ledger for use to read those encryptions without revealing the encryptions, encryption types, or decryption legend; (c) means of sharing encryptions and only the encryptions meant to be shared over networks and with other devices; (d) securing encryptions with additional encryption for on-device and off-device records; (e) securing encryptions with encryption for transport over networks for use on other devices; (f) creating variable lock and key entry encryptions accessible only to specific authorized encrypted code on the device, other devices, and individual authorities of identified software programs; (g) recognizing accessory code not encrypted to the platform's translation readability systems, isolating the code, and eliminating the code; (h) blocking unauthorized access by a software or code that is attempting to obtain data without consent or embed code into another program; (i) blocking unauthorized access within software of any other part of the software to prevent self-breach; (j) readability of software without decrypting the encryptions using an imbedded legend; (k) requesting & receiving data automatically with pre-set parameters or manually using data sharing and a data report with option boxes for information and data; (l) sending data and denying data to be sent automatically and on a case-by-case basis using data sharing and a data report with option boxes for requested information and data; (m) viewing all data requests meant to be unseen but imbedded in the code of a software program using a data report with option boxes for requested information and data.

2. The method of claim 1, wherein an encryption platform account is provided for various purposes of recording, storing, and sharing data with your devices and networks for private use, family, teams, and organizations. This data includes but is not limited to encryption records, information, and software in development and/or use.

3. The method of claim 1, wherein encrypted data can be sent over any network, secure or unsecure, for recording, storing, or sharing in the cloud and be reintegrated into the encryption platform without breach by malware or virus.

4. The method of claim 1, wherein temporary, timed encryption translations with secondary confirmation can be sent to one or more devices over networks. Confirmed transmissions are decrypted and transmissions unconfirmed as received are automatically deleted with a message of not delivered for lack of confirmation.

5. The method of claim 1, wherein each software program is encrypted separately and differently by the developer of the program using the translation matrix. The OS of each individual computer device is encrypted differently than any other OS on any other computer device, even when the OS and hardware are completely identical. The access-points of any software are uniquely encoded to connect only with the core of the device on which the software resides.

6. The method of claim 1, wherein an authorized app store is the gateway for most software downloads and the program is wrapped in app store encryption which is further wrapped in device encryption within an encryption platform account that then transmits the software to a given device. The encrypted software and updates are transmitted over networks to multiple devices for securely updating these devices through the encryption platform and only these updates can connect to existing software program downloads through the encryption platform using uniquely encrypted access points.

7. The method of claim 1, wherein software downloads and updates not connected to the encryption platform are either from an unencrypted app store or a private organization. Unsecure software or data can be downloaded and encrypted for secure use on a computer device and a timed encryption sent to an unsecure device for use of software or data. The unsecure designation relates to software or data not encrypted by the developer or sender due to pre industry-wide use of the encryption platform. Software downloads and updates not in an app store can use the encryption platform account for the purpose of development, dispersion, and use of software by a private organization (e.g. business, non-profit, or government agency).

8. The method of claim 1, wherein the encryption platform is a trust system and any device privately owned by an employee or owned by a team or organization can be denied access by said team or organization.

9. The method of claim 1, wherein non-visual computer systems and devices (e.g. modems, satellites) used for the purpose of transmission of software and data are equipped and so protected by the encryption platform through the use of visual computer devices (e.g. desktops and laptops).

10. The method of claim 1, wherein diagnostic tools on a device can be accessed or diagnostic tools on another device can access a device requiring diagnosis through the diagnosis system in the encryption platform where the core gives temporary access when a person on the device approves such access. Diagnostic tools on an authorized external device can read the code of a computer device requiring diagnosis using the translation matrix and translation legend of encrypted software on said device.

11. A non-transitory computer-readable medium comprising multiple computer programs in an encryption platform, the platform itself encrypted, that when executed by a computer system enables the encryption platform to perform the following process for allowing authorized access while denying access of digital systems to a breach by malware, viruses, and hacking from multiple sources, the method comprising: (a) an encryption made by a translation matrix utilizing multiple random translation types per one encryption, making it an infinite number of possibilities what the original code was before the encryption occurred; (b) a system of recording, naming, and tracking all encryptions in a ledger for use to read those encryptions without revealing the encryptions, encryption types, or decryption legend; (c) means of sharing encryptions and only the encryptions meant to be shared over networks and with other devices; (d) securing encryptions with additional encryption for on-device and off-device records; (e) securing encryptions with encryption for transport over networks for use on other devices; (f) creating variable lock and key entry encryptions accessible only to specific authorized encrypted code on the device, other devices, and individual authorities of identified software programs; (g) recognizing accessory code not encrypted to the platform's translation readability systems, isolating the code, and eliminating the code; (h) blocking unauthorized access by a software or code that is attempting to obtain data without consent or embed code into another program; (i) blocking unauthorized access within software of any other part of the software to prevent self-breach; (j) readability of software without decrypting the encryptions using an imbedded legend; (k) requesting & receiving data automatically with pre-set parameters or manually using data sharing and a data report with option boxes for information and data; (l) sending data and denying data to be sent automatically and on a case-by-case basis using data sharing and a data report with option boxes for requested information and data; (m) viewing all data requests meant to be unseen but imbedded in the code of a software program using a data report with option boxes for requested information and data.

12. The method of claim 11, wherein an encryption platform account is provided for various purposes of recording, storing, and sharing data with your devices and networks for private use, family, teams, and organizations. This data includes but is not limited to encryption records, information, and software in development and/or use.

13. The method of claim 11, wherein encrypted data can be sent over any network, secure or unsecure, for recording, storing, or sharing in the cloud and be reintegrated into the encryption platform without breach by malware or virus.

14. The method of claim 11, wherein temporary, timed encryption translations with secondary confirmation can be sent to one or more devices over networks. Confirmed transmissions are decrypted and transmissions unconfirmed as received are automatically deleted with a message of not delivered for lack of confirmation.

15. The method of claim 11, wherein each software program is encrypted separately and differently by the developer of the program using the translation matrix. The OS of each individual computer device is encrypted differently than any other OS on any other computer device, even when the OS and hardware are completely identical. The access-points of any software are uniquely encoded to connect only with the core of the device on which the software resides.

16. The method of claim 11, wherein an authorized app store is the gateway for most software downloads and the program is wrapped in app store encryption which is further wrapped in device encryption within an encryption platform account that then transmits the software to a given device. The encrypted software and updates are transmitted over networks to multiple devices for securely updating these devices through the encryption platform and only these updates can connect to existing software program downloads through the encryption platform using uniquely encrypted access points.

17. The method of claim 11, wherein software downloads and updates not connected to the encryption platform are either from an unencrypted app store or a private organization. Unsecure software or data can be downloaded and encrypted for secure use on a computer device and a timed encryption sent to an unsecure device for use of software or data. The unsecure designation relates to software or data not encrypted by the developer or sender due to pre industry-wide use of the encryption platform. Software downloads and updates not in an app store can use the encryption platform account for the purpose of development, dispersion, and use of software by a private organization (e.g. business, non-profit, or government agency).

18. The method of claim 11, wherein the encryption platform is a trust system and any device privately owned by an employee or owned by a team or organization can be denied access by said team or organization.

19. The method of claim 11, wherein non-visual computer systems and devices (e.g. modems, satellites) used for the purpose of transmission of software and data are equipped and so protected by the encryption platform through the use of visual computer devices (e.g. desktops and laptops).

20. The method of claim 11, wherein diagnostic tools on a device can be accessed or diagnostic tools on another device can access a device requiring diagnosis through the diagnosis system in the encryption platform where the core gives temporary access when a person on the device approves such access. Diagnostic tools on an authorized external device can read the code of a computer device requiring diagnosis using the translation matrix and translation legend of encrypted software on said device.
